(19) United States
(12) Patent Application Publication
(10) Pub. No.: US 2012/0056808 A1
(43) Pub. Date: Mar. 8, 2012

(54) EVENT TRIGGERING METHOD, SYSTEM, AND COMPUTER PROGRAM PRODUCT

(76) Inventors: Cheng-Han WU, Taipei City (TW); Wen-Tang Chen, Taipei City (TW); Chung-Wen Liao, Taipei City (TW)

(21) Appl. No.: 12/965,475

(22) Filed: Dec. 10, 2010

(30) Foreign Application Priority Data
Sep. 2, 2010 (TW) 099129663

(51) Int. Cl. G06F 3/033

(52) U.S. Cl. 345/158

(57) ABSTRACT

An event triggering method, system, and computer program product are provided, in which an optical spot trajectory tracking is utilized. Firstly, a cursor at a position on the surface of a screen is moved to a preset position through a first optical spot, then, the projecting of the first optical spot is stopped. Next, it is determined whether the preset position is a preset position of a command. Then, a second optical spot is projected to generate a light-triggered signal, and then a processing unit executes the command according to the light-triggered signal.

### CROSS-REFERENCE TO RELATED APPLICATION

This application claims the benefit of Taiwan Patent Application No. 099129663, filed on Sep. 2, 2010, which is hereby incorporated by reference for all purposes as if fully set forth herein.

### BACKGROUND OF THE INVENTION

1. Field of Invention

The present invention relates to an event triggering method, system, and computer program product, and more particularly to an event triggering method by using an optical spot trajectory tracking and a system thereof, in which firstly it is determined whether a cursor position already reaches a command position by a first movement, and then an execute command of an event is determined by a second movement.

2. Related Art

In a presentation, idea and data that a speaker intends to convey usually need to be converted into text, diagrams, or patterns which are projected onto a screen through a projector. A liquid crystal projector usually becomes a projecting source of images, and the images may be diagrams, text, or patterns that a user intends to express. The images are generated by a personal computer (PC) or a notebook computer, and the user can make the images by executing software for their presentation, such as Microsoft PowerPoint. Formats of the images output by the computer include a standard VGA format, and a super VGA or XGA format.

In a conventional presentation system, when a speaker needs to execute a command to jump to another slide, he/she usually needs to return to the PC to draw a mouse to execute the command, or can only slowly move the cursor on a screen depending on a function of a touchpad on a laser pointing device. These motions easily distract the speaker, and slow the presentation, so that the speaker can not make the real-time interaction with audiences. For example, when an audience asks a question, the speaker cannot immediately point out a keyword indicated on the screen and make a real-time response. The present invention can provide real-time screen operation and command transmission, so as to overcome the space limitation, and provide a more convenient application tool.

In related prior arts, such as a mouse having a pointer function, this prior art emphasizes that a laser pointer is mounted in the body of a mouse. The disadvantages lie in that there still existing problems of a space limitation during the presentation and incapable of making a sufficient and quick interaction with audiences, that is to say, the operating range is also limited by the length of a line connecting to the mouse.

Further, in a switching device of a remote indicator of a presentation system, a main function of the remote indicator is only to control the presentation procedure, such as clicking to a next slide, enlarging and so on, but the remote indicator does not have functions of remote controlling a computer cursor and executing commands in Windows through the cursor (equivalent to a function of a desktop computer mouse).

The aforementioned prior arts fail to provide a function of direct transmission of spot coordinates, and require a switch between the laser pointing device and the mouse to perform the function, which may slow the presentation and distract the audiences from the speaker.

### SUMMARY OF THE INVENTION

Accordingly, the invention is directed to an event triggering method system, and computer program product, in which an optical spot trajectory tracking is utilized, such that the purpose of improving the stability of triggering an event of a command can be achieved.

The invention provides an event triggering method by using an optical spot trajectory tracking, which includes the following steps. Firstly, a first optical spot output by a photoelectric indicator unit is projected on a position of a surface. The first optical spot is moved to a preset position on the surface by the photoelectric indicator unit. An optical signal of the first optical spot at the preset position is sensed by an optical sensing unit. A processing unit calculates a coordinate value of the preset position according to the first optical signal, and generates a first control signal, and then the projecting of the first optical spot is stopped.

Next, it is determined whether the preset position is a preset position of a command, then a second optical spot output by the photoelectric indicator unit is projected on the surface, and next, the photoelectric indicator unit makes the second optical spot to generate a light-triggered signal. Finally, the light-triggered signal is received by the optical sensing unit, and the processing unit executes the command according to the light-triggered signal.

In one embodiment, the surface unit includes a surface of a screen.

In one embodiment, the photoelectric indicator unit emits an optical spot signal.

In one embodiment, the optical sensing unit includes a light intensity sensing element and a signal register. The light intensity sensing element is used for detecting brightness of the first optical spot and the second optical spot to output a sensing signal and the signal register is connected with an output end of the light intensity sensing element to temporarily store and buffer a change of the sensing signal.

In one embodiment, the processing unit includes a computer device, and the processing unit is electrically connected with a projection device to make a projection on the surface, such that an event of a command may be projected onto the surface when the photoelectric indicator unit is triggering the command.

The invention further provides an event triggering system by using an optical spot trajectory tracking. The event triggering system may include a projection display unit, a photoelectric indicator unit, an optical sensing unit, and a processing unit. A cursor is projected onto the projection display unit displays. The photoelectric indicator unit projects a first optical spot and a second optical spot onto the projection display unit, the first optical spot is moved to a preset position to generate a optical signal; and the photoelectric indicator unit makes the second optical spot to generate a light-triggered signal. The optical sensing unit senses the first optical signal of the first optical spot and the light-triggered signal of the second optical spot. The processing unit is connected with an output end of the optical sensing unit, so as to generate a control signal according to a coordinate value of the first optical signal of the first optical spot, and execute a command according to the light-triggered signal of the second optical spot.

The invention also provides a computer program product for triggering an event by using an optical spot trajectory tracking, which may be loaded into a computer to execute optical spot trajectory tracking and trigger a command.

The invention utilizes a hand movement recognition technology in combination with optical spot tracking to recognize an operation behavior of an operator. Furthermore, a spot position is obtained through photographic analysis, a cursor is quickly moved to a position where is a preset position of a command, and then a corresponding event is triggered with a second movement, so that the operation efficiency is greatly improved in both the speed and the stability.

### BRIEF DESCRIPTION OF THE DRAWINGS

The present invention will become more fully understood from the detailed description given herein below for illustration only, and thus are not limitative of the present invention, and wherein:

FIG. 1 is a flow chart of steps according to one embodiment of the invention; and

FIG. 2A˜FIG. 2F are schematic views explaining how the system works according to one embodiment of the invention.

### DETAILED DESCRIPTION OF THE INVENTION

In order to make the aforementioned features and advantages of the present invention more comprehensible, embodiments are illustrated in detail hereinafter with reference to the accompanying drawings.

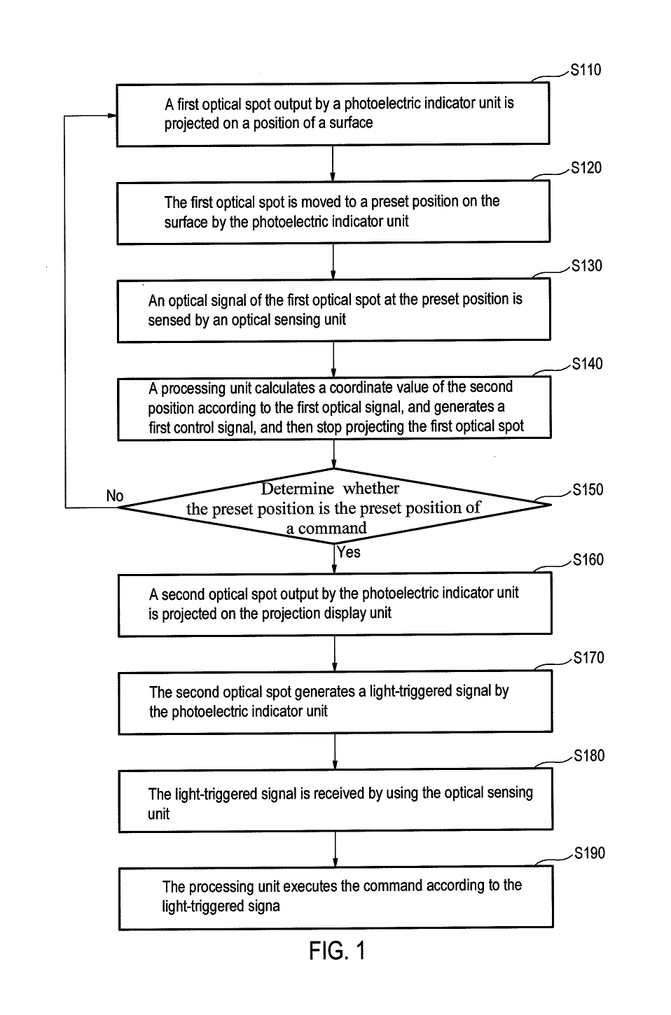

FIG. 1 is a flow chart of steps according to an embodiment of the present invention. An event triggering method by using an optical spot trajectory tracking according to the present invention includes the following steps.

In Step S110, a first optical spot output by a photoelectric indicator unit is projected on a position of a surface.

In this embodiment, the surface may be a surface of a projection display unit or a surface of a wall but is not limited thereto.

In Step S120, the first optical spot is moved to a preset position on the surface by the photoelectric indicator unit.

In Step S130, a optical signal of the first optical spot at the preset position is sensed by an optical sensing unit.

In this embodiment, the photoelectric indicator unit emits an optical spot, for example, a laser spot. The optical sensing unit further includes a light intensity sensing element and a signal register. The light intensity sensing element detects brightness of the first optical spot and a second optical spot to output a sensing signal, and the signal register is connected to an output end of the light intensity sensing element to temporarily store and buffer the changes of the sensing signals.

In Step S140, a processing unit calculates a coordinate value of the preset position according to the first optical signal, and generates a first control signal, and then stops projecting the first optical spot.

In this embodiment, the processing unit is electrically connected with a projection device, so as to project information onto the surface. The processing unit may be a computer device, PDAs, or smart phones, and so on but not limited to.

In Step S150, it is determined whether the preset position is the preset position of a command, and if yes, a next step is performed; otherwise, the procedure returns to Step S110.

In this embodiment, if the preset position is not a preset position of a command, no event can be executed at this position, so that the procedure returns to the initial step, and the optical spot continues to move until reaching a preset position of a command.

In Step S160, a second optical spot output by the photoelectric indicator unit is projected on the projection display unit.

In Step S170, the second optical spot generates a light-triggered signal by the photoelectric indicator unit.

In this embodiment, if it is determined that a final position of the first optical spot is in the position of a command, the user can move the photoelectric indicator unit by a hand movement so as to make the second optical spot to have a displacement, or to generate a control signal by flickering the second optical spot.

In Step S180, the light-triggered signal is received by the optical sensing unit.

In Step S190, the processing unit executes the command according to the light-triggered signal.

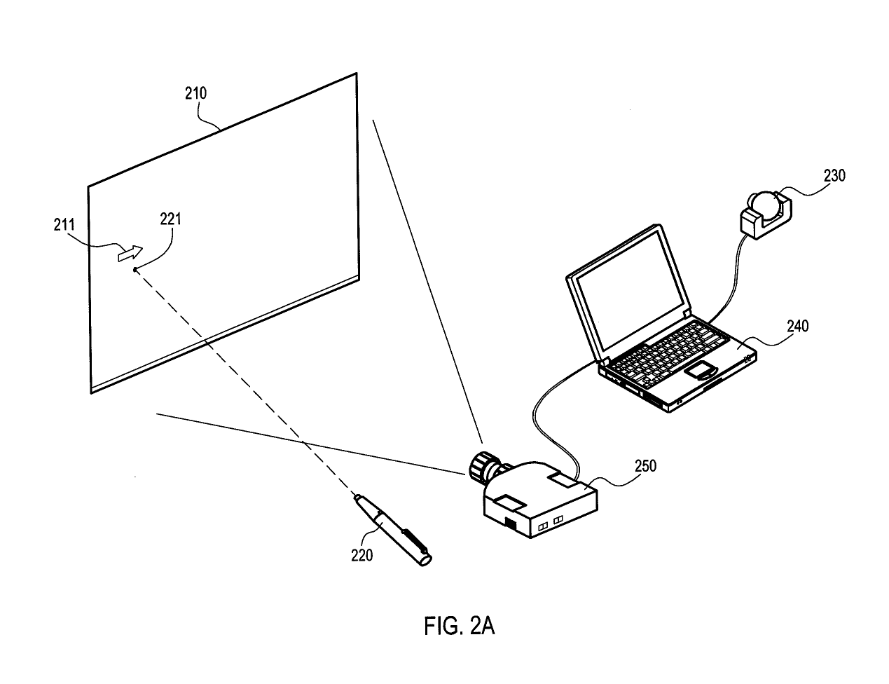

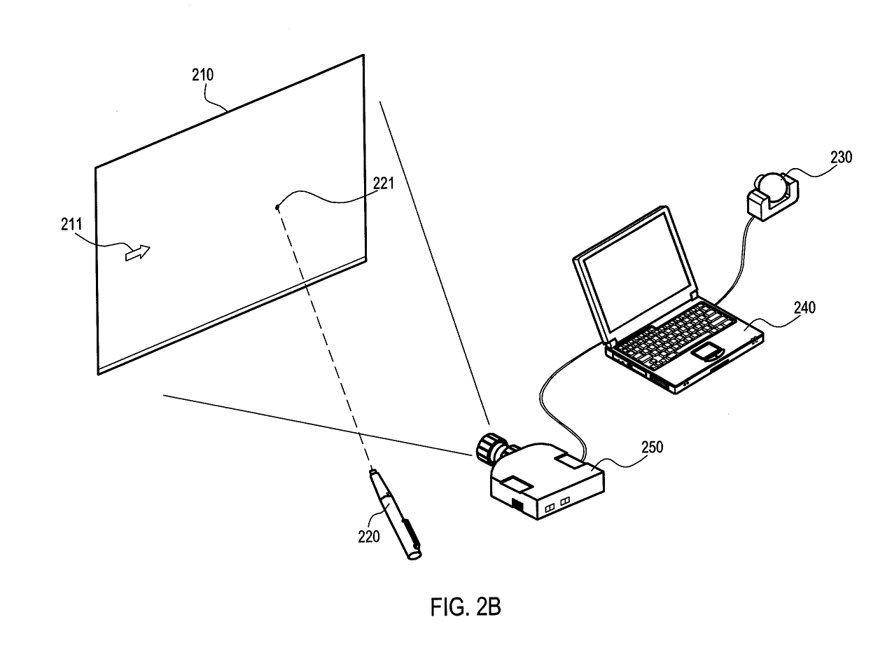

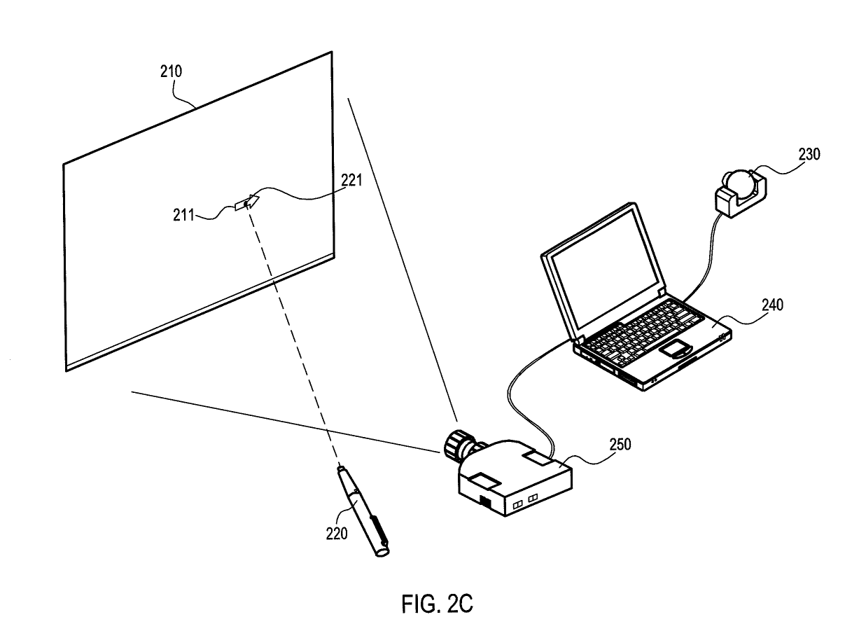

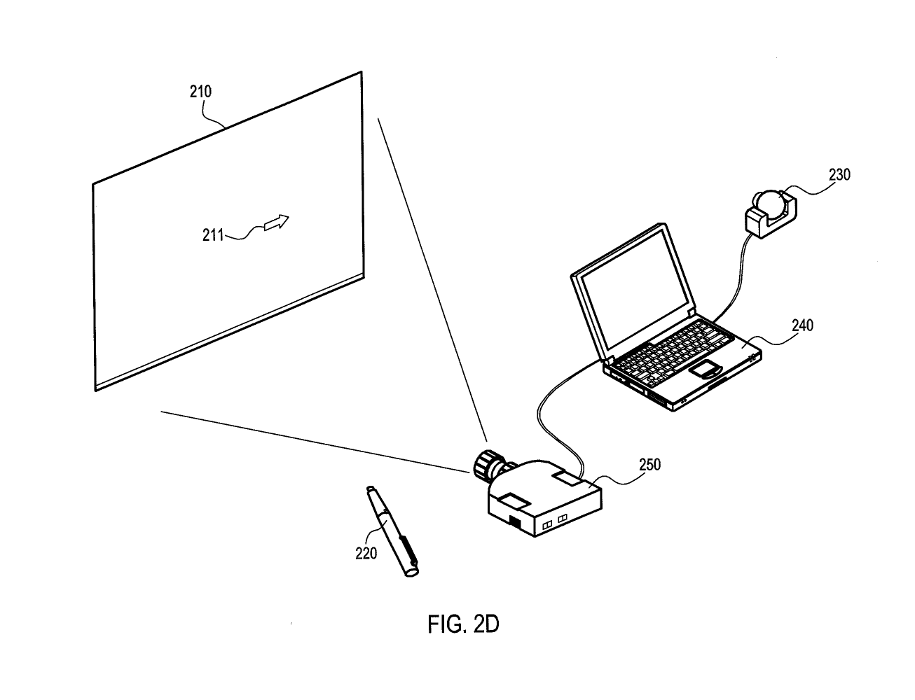

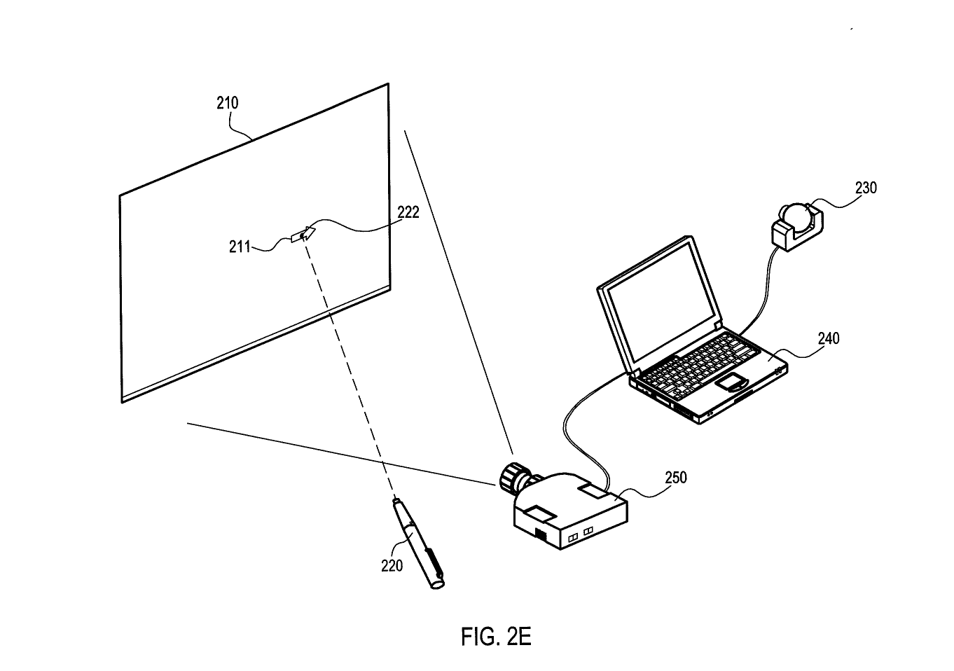

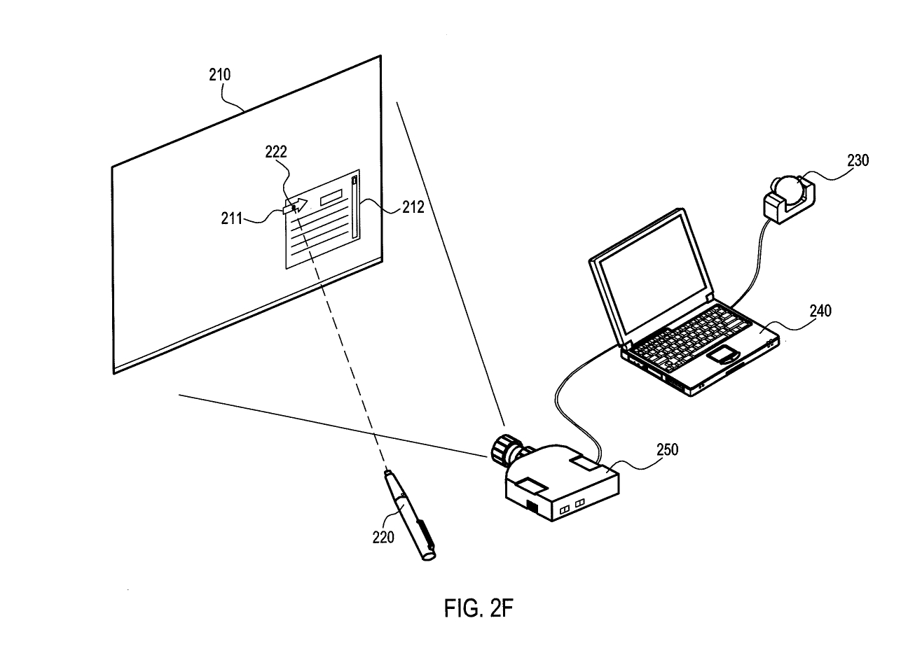

FIGS. 2A to 2F are schematic views explaining how the system works according to one embodiment of the invention. In the figures, an event triggering system by using an optical spot trajectory tracking may include, for example, a screen 210, a laser pen 220, a photographing device 230, a processing unit 240, and a projector 250. The projector 250 is electrically connected with the processing unit 240, so as to project slides which may contain diagrams, text, patterns, and so on, from the processing unit 240. A cursor 211 may be also projected from the processing unit 240 as well. In this embodiment, the cursor 211 is only used to facilitate the illustration, but the embodiment is not limited thereto. The photographing device 230 may have an optical sensing unit, or the photographing device 230 may be replaced by an optical sensing unit. In addition, the processing unit 240 may be computer devices, PDAs, smart phones, and so on, but not limited to.

As shown in FIG. 2A, the cursor 211 is displayed on the screen 210, and a first optical spot 221 is projected onto a surface of the screen 210 by the laser pen 220. At this time, the first optical spot 221 can be projected at a place on the screen 210 different from that of the cursor 211, or it can also be projected on the cursor 211, so as to overlap with the cursor 211. The projection display unit is preferably a screen, but is not limited thereto.

As shown in FIG. 2B, the first optical spot 221 is moved on the screen 210 by the laser pen 220, and the first optical spot 221 is moved to a preset position.

At the same time, when the first optical spot 221 is moved from an original position to the preset position, the moving path of the first optical spot 221 is captured by the photographing device 230; therefore, the cursor 211 is moved according to a trajectory of the moving path of the first optical spot 221.

As shown in FIG. 2C, according to an optical signal coordinate calculated by the processing unit 240, the cursor 211 is moved to the preset position of the first optical spot 221.

At this time, an optical signal of the first optical spot 221 at the preset position is sensed by the optical sensing unit of the photographing device 230. The processing unit 240 electrically connected with the photographing device 230 calculates a coordinate value of the preset position according to the first optical signal.

As shown in FIG. 2D, after the cursor 211 is moved to the position of the first optical spot 221, the laser pen 220 stops emitting the first optical spot 221 to the screen 210, and at this time, only the cursor 211 is displayed on the screen 210.

Still further, when the first optical spot 221 begins to be projected to the screen 210, the cursor 211 also begins to move almost at the same time during the process of moving the first optical spot 221. In addition, by the action of stopping the projection of the first optical spot 221, a final position of the first optical spot 221 and the cursor 211 is determined.

As shown in FIG. 2E, the laser pen 220 is turned on again to emit a second optical spot 222 onto the screen 210.

If it is determined that the final position of the first optical spot 221 and the cursor 211 is the preset position of the command, at this time, the second optical spot 222 emitted by the laser pen 220 can trigger an event of a command to execute the command. If the final position of the first optical spot 221 and the cursor 211 is not a preset position of a command, the second optical spot 222 emitted by the laser pen 220 can only perform to move the cursor 211. In this embodiment, the final position of the first optical spot 221 and the cursor 211 is assumed to be the preset position of the command.

As shown in FIG. 2F, the laser pen 220 is moved by a hand movement of the user in order to make the second optical spot 222 to have a displacement, or a control signal is generated by flickering the second optical spot 222. Through the control signal, a command is executed on the screen 210.

In this embodiment, for ease of illustration, a menu 212 is illustrated as an example, but is not limited to. Herein, the executed command can be an operation command such as highlight, select, enlarge, reduce, hyperlink, and page shift.

Additionally, the present invention further provides a computer program product for triggering an event by using optical spot trajectory tracking, which may be loaded into a computer to execute optical spot trajectory tracking and trigger a command, and the steps are the same as above described so the it will not be described herein again.

Although the present invention has been disclosed through the foregoing embodiments, they are not intended to limit the present invention. Equivalent replacements of variations and modifications made by persons skilled in the art without departing from the spirit and the scope of the present invention still fall within the protection scope of the present invention.

What is claimed is:

1. An event triggering method by using an optical spot trajectory tracking, comprising:
projecting a first optical spot by a photoelectric indicator unit at a position on a surface;
moving the first optical spot to a preset position by the photoelectric indicator unit;
sensing an optical signal of the first optical spot at the preset position by an optical sensing unit;
calculating a coordinate value of the preset position according to the first optical signal, and generating a first control signal by a processing unit, and then stopping projection of the first optical spot;
determining whether the preset position is a preset position of a command;
projecting a second optical spot by the photoelectric indicator unit on the surface;
making the second optical spot to generate a light-triggered signal by the photoelectric indicator unit;
receiving the light-triggered signal by the optical sensing unit; and
executing the command according to the light-triggered signal by the processing unit.

2. The event triggering method by using an optical spot trajectory tracking according to claim 1, wherein the surface comprises a surface of a screen.

3. The event triggering method by using an optical spot trajectory tracking according to claim 1, wherein the photoelectric indicator unit emits an optical spot signal.

4. The event triggering method by using an optical spot trajectory tracking according to claim 1, wherein the optical sensing unit comprises:
a light intensity sensing element, for detecting brightness of the first optical spot and the second optical spot to output a sensing signal; and
a signal register, connected with an output end of the light intensity sensing element to temporarily store and buffer a change of the sensing signal.

5. The event triggering method by using an optical spot trajectory tracking according to claim 1, wherein the processing unit comprises a computer device.

6. The event triggering method according to claim 5, wherein the processing unit is electrically connected with a projection device to make a projection on the surface.

7. An event triggering system by using an optical spot trajectory tracking, comprising:
a projection display unit;
a photoelectric indicator unit, for outputting a first optical spot and a second optical spot, wherein the first optical spot is projected onto the projection display unit, the first optical spot is moved to a preset position of a command to generate an optical signal, and the photoelectric indicator unit makes the second optical spot to generate a light-triggered signal;
an optical sensing unit, for sensing the first optical signal of the first optical spot and the light-triggered signal of the second optical spot; and
a processing unit, connected with an output end of the optical sensing unit, so as to generate a control signal according to a coordinate value of the first optical signal of the first optical spot, and execute the command according to the light-triggered signal of the second optical spot.

8. The event triggering system by using an optical spot trajectory tracking according to claim 7, wherein the projection display unit is a screen.

9. The event triggering system according to claim 7, wherein the photoelectric indicator unit emits an optical spot signal.

10. The event triggering system by using an optical spot trajectory tracking according to claim 7, wherein the optical sensing unit comprises:
a light intensity sensing element, for detecting brightness of the first optical spot and the second optical spot to output a sensing signal; and
a signal register, connected with an output end of the light intensity sensing element to temporarily store and buffer a change of the sensing signal.

11. The event triggering system by using an optical spot trajectory tracking according to claim 7, wherein the processing unit is a computer device.

12. The event triggering system by using an optical spot trajectory tracking according to claim 11, wherein the processing unit is electrically connected with a projection device to make a projection on the projection display unit.

13. An computer program product for triggering an event by using an optical spot trajectory tracking, being loaded into a computer to execute following steps of triggering an event by using an optical spot trajectory tracking:
projecting a first optical spot by a photoelectric indicator unit on a surface;
moving the first optical spot to a preset position on the surface by the photoelectric indicator unit;
sensing an optical signal of the first optical spot at the preset position by an optical sensing unit;
calculating a coordinate value of the preset position according to the first optical signal, and generating a first control signal by a processing unit, and then stopping outputting the first optical spot;
determining whether the preset position is a preset position of a command;
projecting a second optical spot by the photoelectric indicator unit on the surface;
making the second optical spot to generate a light-triggered signal by the photoelectric indicator unit;
receiving the light-triggered signal by the optical sensing unit; and
executing the command according to the light-triggered signal by the processing unit.
